(19) United States
(12) Patent Application Publication
(10) Pub. No.: US 2024/0042836 A1
(43) Pub. Date: Feb. 8, 2024

(54) VEHICLE DISPLAY APPARATUS

(71) Applicant: Alps Alpine Co., Ltd., Tokyo (JP)

(72) Inventors: Taro Iwamoto, Tokyo (JP); Manabu Fujiwara, Iwaki (JP); Shuhei Matsuda, Tokyo (JP); Masatada Muramoto, Tokyo (JP)

(73) Assignee: Alps Alpine Co., Ltd., Tokyo (JP)

(21) Appl. No.: 18/356,747

(22) Filed: Jul. 21, 2023

(30) Foreign Application Priority Data
Aug. 5, 2022 (JP) 2022-125522

(51) Int. Cl. B60J 3/04; G09G 3/00

(52) U.S. Cl. CPC B60J 3/04; G09G 3/001; G09G 2358/00; G09G 2320/0686; G09G 2320/0242; G09G 2354/00; G09G 2380/10

(57) ABSTRACT

A vehicle display apparatus includes: a transparent display that is installed on a window glass of a vehicle and displays an image of content which is a display target; a mask layer that is disposed to overlap the transparent display and is capable of changing a visibility of a display region of the image from outside the vehicle; and a mask setting unit that sets a visibility of the mask layer depending on details of the content.

### RELATED APPLICATION

The present application claims priority to Japanese Patent Application No. 2022-125522, filed on Aug. 5, 2022, the entirety of which is hereby incorporated by reference.

### BACKGROUND

### 1. Field

The present disclosure relates to a vehicle display apparatus that displays visual content, such as an image or a video, on a window of a vehicle.

### 2. Description of the Related Art

Conventionally, an information processing apparatus in which a display device that displays content is changed, or the transmittance of a window close to another moving body is varied, in consideration of the sensitivity of the content which is a display target, and in order to reduce the possibility of viewing from another moving body in the vicinity (see for example, see JP 2021-26442 A). In that information processing apparatus, when highly sensitive information is displayed on a display, a direction or the like of a line of sight of an occupant of another moving body around a host vehicle is detected to determine a possibility of viewing, and the transmittance of a window enabling viewing of the display is reduced as necessary, thereby protecting from viewing the information.

### SUMMARY

In the information processing apparatus disclosed in JP 2021-26442 A described above, problems arise in that the possibility of viewing the information displayed on the display is determined by both a complicated configuration, such as a camera or a proximity sensor, in order to ascertain the presence of another moving object and/or a direction of a line of sight of an occupant, as well as complicated processing of information obtained using the camera or the proximity sensor.

In particular, in the information processing apparatus described above, it is assumed that the information displayed on the display installed in the vehicle interior may be viewed from the outside through the window of the host vehicle. Therefore, when information with a high degree of sensitivity is displayed on the display, and the transmittance of the window is reduced only according to the presence or absence of display of information with a high degree of sensitivity, the transmittance of the window has to be always reduced during the display of this information, but such a reduction in transmittance is not desirable from the viewpoint of reducing a feeling of obstruction for an occupant of the host vehicle or the like. On the other hand, in the information processing apparatus described above, the presence or absence of another moving object around the host vehicle and/or the direction of the line of sight of an occupant of the moving object are detected, and the transmittance of the window is limited only when necessary.

As in the present disclosure, in a case where a transparent display overlaps a window of the host vehicle and various types of information are displayed, information reflected on the window itself may be viewed from the outside, rather than viewing the displayed information through the window, and it is easier to grasp the content of the displayed information in that way, as compared to viewing the information displayed on the display in the vehicle interior through the window. Therefore, measures suitable for such a use form are desired. In addition, in the information processing apparatus described above, a position of the display viewed through the window changes on the window depending on a position of an occupant of another vehicle, a pedestrian outside the vehicle, or the like; however, in the case of the transparent display provided on the window, as in the present disclosure, the position of the display on the window is fixed, and thus it is considered that there is no need to reduce the transmittance of the entire window when information has to be protected from external viewing.

The present disclosure has been made in view of the above-described circumstances, and an object of the present disclosure is to provide a vehicle display apparatus capable of preventing viewing of displayed information by a simple configuration and simple processing details, when the information is displayed on a transparent display installed on a window.

In order to solve the problems described above, a vehicle display apparatus of the present disclosure includes: a transparent display that is installed on a window of a vehicle, and displays an image of content which is a display target; a mask unit that is disposed to overlap the transparent display, and is capable of changing a visibility of a display region of the image from outside the vehicle; and, a visibility setting unit that sets a visibility of the mask unit depending on details of the content.

The mask unit is disposed to overlap a back side of the transparent display installed on the window of the vehicle, and the visibility of the mask unit may be varied. In this manner, it is possible to display an image of content normally while scenery outside the vehicle is viewed through the window, and it is possible to reduce the visibility of the image of the content from the outside of the vehicle simply by changing the settings of the mask unit. Hence, it is possible to prevent viewing of the display information (content) by a simple configuration and simple processing details.

In addition, the visibility setting unit may change the visibility by varying transparency of the mask unit. Specifically, the visibility setting unit may reduce the visibility by switching from a transparent screen to an opaque screen. The opaque screen may be a screen of a predetermined color (particularly, black). A reduction in transparency, for example, a change from a transparent screen to an opaque screen (such as a black screen), enables the visibility from outside of the vehicle to be reliably reduced.

In addition, the visibility setting unit may reduce the visibility of the mask unit when the details of the content are a target of privacy protection. Alternatively, the visibility setting unit may reduce the visibility of the mask unit when the details of the content are a target of secrecy. As a result, it is possible to make the details of the content invisible from the outside, only when the privacy protection is required, or when confidentiality needs to be ensured.

In addition, the visibility setting unit may reduce the visibility of the mask unit when the details of the content are a target of external viewing. Consequently, it is possible to prevent the details of the content from being viewed from the outside when the content includes details which need to be visually observed, and at the same time, it is possible to improve the visibility of the content because external scenery cannot be viewed through the window when the content is displayed.

In addition, the visibility setting unit may not reduce the visibility of the mask unit when the details of the content indicate information that complements a background that is visible to an occupant of a host vehicle through the transparent display, the information to be displayed assuming a state in which the background is visible. In addition, the visibility setting unit may reduce the visibility of the mask unit when the details of the content do not indicate information which is to be displayed assuming a state in which a background is visible to an occupant of a host vehicle through the transparent display. Consequently, it is possible to change the visibility of the content from the outside depending on whether or not it is assumed that the background of the outside is visible through the transparent display, and thus it is possible to improve the visibility of the content, as necessary.

In addition, the mask unit may be capable of changing the visibility of a part of a display region of the transparent display, and the visibility setting unit reduces the visibility of the mask unit for a part of the display region when the content to be displayed with a visibility reduction corresponds to the part of the display region. Consequently, it is possible to reduce the visibility of only a portion which is a visibility reduction target.

In addition, the content may be associated with metadata indicating whether or not a visibility reduction needs to be performed by the mask unit, and the visibility setting unit sets the visibility of the mask unit based on the metadata. Consequently, it is easy to determine whether or not the visibility reduction needs to be performed for each content.

In addition, whether or not a visibility reduction needs to be performed by the mask unit may be set for each application that displays an image of the content, and the visibility setting unit sets the visibility reduction for the mask unit when the settings indicate that the visibility reduction needs to be performed are provided for an application that displays the image of the content. Consequently, it is easy to determine whether or not the visibility reduction needs to be performed for each application that displays the image of the content.

### BRIEF DESCRIPTION OF THE DRAWINGS

FIG. 1 is a diagram illustrating a configuration of a vehicle display apparatus according to an embodiment of the present disclosure;

FIG. 2 is a view illustrating an installation state of a transparent display and a mask layer;

FIG. 3 is a flowchart illustrating an operation procedure of setting a visibility of the mask layer when an image of content is displayed;

FIG. 4 is a diagram illustrating a modification example in which information such as a product advertisement is displayed to the outside when a transparent display is made opaque; and

FIG. 5 is a diagram illustrating another modification example in which opportunities of mask processing are limited depending on a situation outside the vehicle.

### DETAILED DESCRIPTION

Hereinafter, a vehicle display apparatus according to an embodiment of the present disclosure will be described with reference to the drawings.

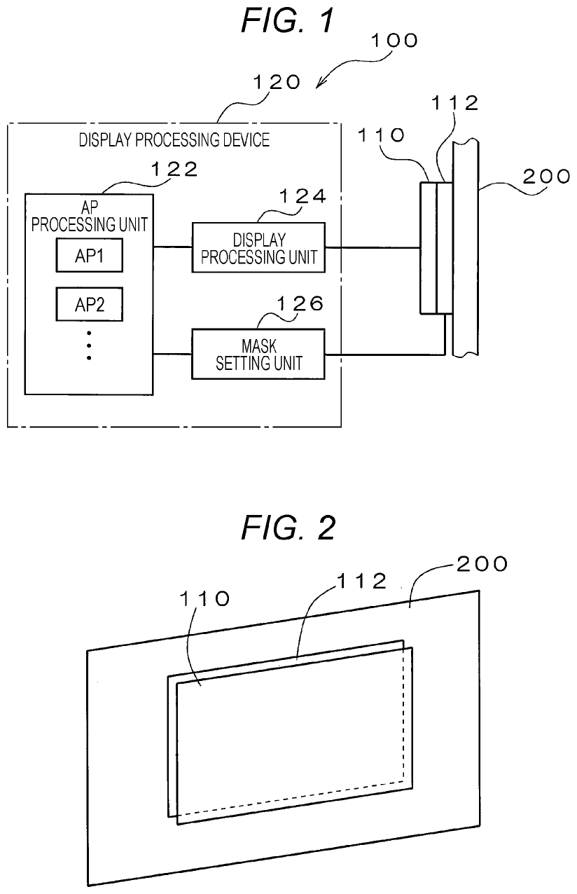

FIG. 1 is a diagram illustrating a configuration of a vehicle display apparatus 100 according to the embodiment. The vehicle display apparatus 100 includes a transparent display 110, a mask layer 112, and a display processing device 120.

The transparent display 110 is installed to overlap window glass 200 of a vehicle and displays images of various contents. In addition, the mask layer 112 is disposed to overlap the transparent display 110, specifically, between the window glass 200 and the transparent display 110. FIG. 2 is a view illustrating an installation state of the transparent display 110 and the mask layer 112. The mask layer 112 and the transparent display 110 are disposed on the window glass 200 in this order in an overlapping manner.

In addition, as illustrated in FIG. 1, the display processing device 120 includes an application (AP) processing unit 122, a display processing unit 124, and a mask setting unit 126. Those skilled in the art will understand that any one or more of the “units” disclosed and described herein may be implemented with circuitry, a controller, a hardwired processor, and/or a processor configured to execute instructions stored in a memory.

The application processing unit 122 selects one or a plurality of applications from a plurality of applications (AP1, AP2, . . . ) and executes the selected applications. For example, the applications are selectively executed, and thereby a navigation operation, a moving image reproducing operation, an Internet browsing operation, a mail transmitting/receiving operation, an audio reproducing operation, a presentation material display operation, or the like is performed. In addition, with each of these operations, content for display is created. In the embodiment, a process of variably setting a visibility from the outside of the vehicle depending on details of the content is performed with respect to the display of the image of the content. Details of the process will be described below.

The display processing unit 124 receives image data of content for each application from the application processing unit 122 and displays an image of the content corresponding to the image data on the transparent display 110.

The mask setting unit 126 changes the visibility from the outside of the vehicle, for example, by varying the transparency. Further, when the visibility from the outside of the vehicle is reduced, the visibility of the outside surroundings is also reduced when viewed from the inside of the vehicle.

The above-described mask layer 112 corresponds to a mask unit, and the mask setting unit 126 and the application processing unit 122 correspond to a visibility setting means.

The vehicle display apparatus 100 has such a configuration described above. Next, an operation of varying the visibility from the outside depending on the details of the content to be displayed will be described.

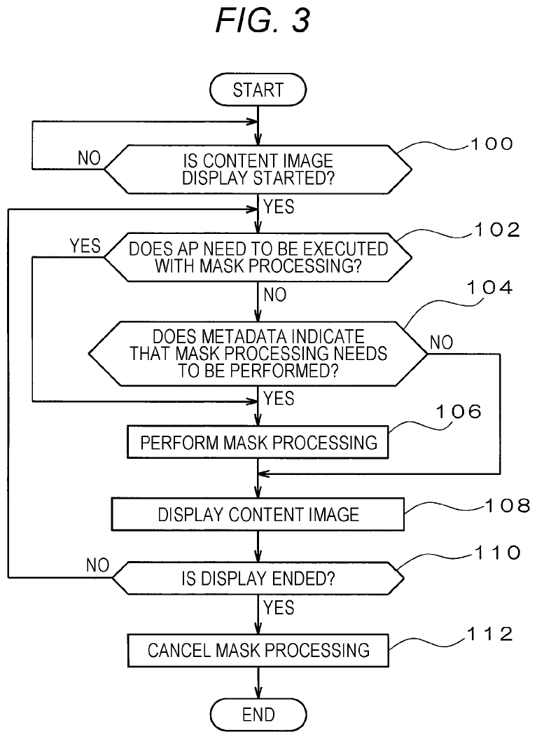

FIG. 3 is a flowchart illustrating an operation procedure of setting the visibility of the mask layer 112 when the image of the content is displayed. The mask setting unit 126 determines whether or not any one of the applications is executed by the application processing unit 122 to start image display of the content (Step 100). For example, at a start of execution of an application, this determination can be made by acquiring an indication of the start and identification information of the executed application from the application processing unit 122. When the image display is not started, a negative determination is made, and this determination is repeated. In addition, when image display of any content is started, an affirmative determination is made in the determination of Step 100.

Meanwhile, the visibility of the mask layer 112 is reduced (opacified) depending on the details of the content which is a display target, and the target content may be determined by any one of the following methods.

(Case 1) Regarding a specific application for which a visibility reduction is designated, the visibility from the outside is reduced with respect to an image of content displayed at a time of execution of the application. For example, there may be a need to protect privacy of a user and/or secure confidentiality of company information, or the like, such that it is desirable that an image of content displayed be invisible from the outside, when an application is executed that performs an e-mail transmitting/receiving operation, or an application is executed that performs a presentation material display operation of a company. Whether or not the application corresponds to such an application is set in advance (for example, may be set by the user himself/herself using a setting screen), and the mask setting unit 126 can recognize whether or not the visibility is to be reduced when the application is executed.

(Case 2) When data of a content includes metadata indicating that visibility for an image of the content from the outside is to be reduced (indicating that mask processing needs to be performed), the visibility from the outside is reduced on the basis of the metadata. It is conceivable that the metadata is set corresponding to the content in order to prevent the content accompanied by a password input or the like during the Internet browsing operation from being viewed from the outside.

Next, the mask setting unit 126 determines whether or not an application that needs to be executed with a visibility reduction of a content image (AP to be executed with mask processing) has been executed (whether or not this case corresponds to Case 1) (Step 102). If not, a negative determination is made. Next, the mask setting unit 126 determines whether or not the metadata indicates visibility reduction of the content image (whether or not this case corresponds to Case 2) (Step 104). If a case corresponds Case 1 or Case 2, an affirmative determination is made in Step 102 or Step 104.

Next, the mask setting unit 126 performs mask processing for reducing the transparency of the mask layer 112, in order to make the image of the content invisible from the outside (Step 106). For example, the mask processing is performed by switching a screen of the mask layer from an illumination state to an opaque screen.

The opaque screen is desirably a screen of a predetermined color, particularly, black, but a screen of a color other than black or a screen displaying wallpaper or the like having a predetermined pattern may be used.

Thereafter, the display processing unit 124 displays the image of the content on the transparent display 110 based on the image data transmitted from the application processing unit 122 (Step 108).

Further, when a case does not correspond to both Case 1 and Case 2, a negative determination is made in the determinations of Steps 104 and 106, and the content image of Step 108 is displayed without undergoing the mask processing of Step 106.

Next, the mask setting unit 126 determines whether or not the image display of the content is ended (Step 110). When the image display continues, a negative determination is made, the process returns to Step 102 to continue a series of operations and repeat a series of operations including a determination of whether or not the mask processing needs to be performed. In addition, when the image display is ended, an affirmative determination is made in the determination of Step 110. Next, the mask setting unit 126 cancels the mask processing (Step 112). Further, when the mask processing in Step 106 is not performed, this cancellation operation is omitted.

As described above, in the vehicle display apparatus 100, the mask layer 112 is disposed to overlap a back side of the transparent display 110 installed on the window glass 200 of the vehicle, and the visibility of the mask layer 112 may be varied. In this manner, it is possible to display an image of content normally while scenery outside the vehicle is viewed through the window glass 200, and it is possible to reduce the visibility of the image of the content from the outside of the vehicle only by changing the settings of the mask layer 112. Hence, it is possible to prevent viewing of displayed information (content) by a simple configuration and simple processing details.

In particular, the visibility is changed by varying the transparency of the mask layer 112, specifically, the visibility is reduced by switching the transparent screen to an opaque (predetermined color, desirably black) screen, and the visibility of the content image from the outside of the vehicle can be reliably reduced. Consequently, it is possible to make the image of the content invisible from the outside only when the privacy protection is required or when confidentiality needs to be ensured.

In addition, when it is set for each application whether or not visibility reduction needs to be performed by the mask layer 112 , and the setting of visibility reduction is performed when the application to be executed indicates that visibility reduction needs to be performed, it is possible to easily determine whether or not the visibility reduction needs to be performed, for each application that displays the image of the content.

Alternatively, metadata indicating whether or not visibility reduction of the display image needs to be performed is associated with each content, and thereby it is easy to determine whether or not the visibility reduction needs to be performed for each content, based on the metadata.

The present disclosure is not limited to the embodiment described above, and it is possible to perform various modifications within the scope of the present disclosure. For example, in the embodiment described above, the mask layer 112 is provided to correspond to the entire transparent display 110, and the visibility reduction (transparent/opaque) of the mask layer 112 is set for the entire transparent display 110 for each application or for each content. However, when the content which needs to be displayed with the visibility reduction corresponds to a part of a display region, the visibility of the mask layer 112 may be reduced only for this part of the display region. The mask layer 112 is configured of a plurality of pixels, and switching between a transparent pixel and a black pixel for each pixel may be performed. In this manner, the visibility of a partial region of the mask layer 112 can be reduced, and the visibility can be reduced only at a portion which is a visibility reduction target. For example, it is conceivable that only a portion where text of an email to be transmitted and received is displayed is subjected to mask processing (opacified), or only a password input region is subjected to mask processing, for content accompanied by password input, during an Internet browsing operation.

In the embodiment described above, it is assumed that the display image of the content is not visible from the outside for purposes of the privacy protection of the user and ensuring confidentiality of company information, and the like; however, whether or not the visibility reduction (opacification) needs to be performed may be determined on the basis of other criteria.

For example, the mask setting unit 126 may reduce the visibility of a content image that needs to be visually observed. In the case of reproducing a moving image, such as a movie, the content image needs to be visually observed, and there is an advantage in that the visibility is improved and it is easy to concentrate on the details of the content by setting the background to an opaque screen by the mask processing. On the other hand, when reproduction information or weather information at a time of audio reproduction is viewed, a landscape outside the vehicle may be reflected through the transparent display 110, without performing the mask processing. In addition, visual observation may also be required in a case of a videophone or a videoconference, such that it may be desirable to set the background to an opaque screen by mask processing. As described above, it is possible to prevent details of the content from being viewed from the outside when the content includes the details which need to be visually observed, and at the same time, it is possible to improve the visibility of the content because external scenery cannot be viewed through the window when the content is displayed.

In addition, the mask setting unit 126 enables the visibility not to be reduced when the details of the content indicate information that complements a background that is visible to an occupant of a host vehicle through the transparent display 110 (AR point information or the like), the information to be displayed assuming a state in which the background is visible. In addition, the mask setting unit 126 reduces the visibility by the mask processing when the details of the content do not indicate information which is to be displayed assuming a state in which a background is visible to an occupant of a host vehicle through the transparent display 110 (menu information or the like of a restaurant). Consequently, it is possible to change the visibility of the content from the outside depending on whether or not it is assumed that the background of the outside is visible through the transparent display 110, and thus it is possible to improve the visibility of the content as necessary.

In the embodiment described above, the visibility of the mask layer 112 is reduced so that the image of the content cannot be viewed from the outside, but information such as a product advertisement may be displayed to the outside using this invisible region.

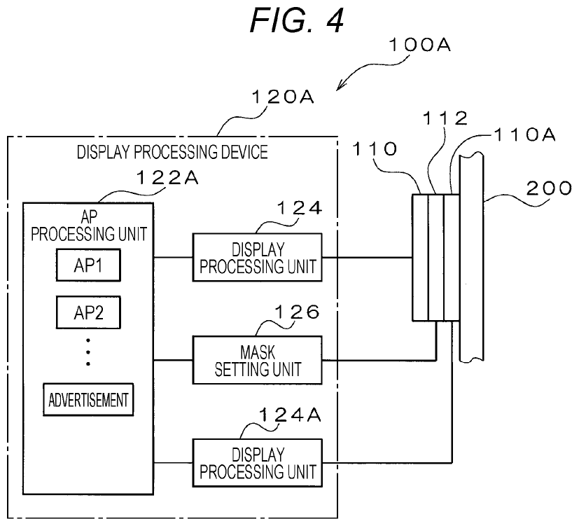

FIG. 4 is a diagram illustrating a modification example in which information such as a product advertisement is displayed to the outside when the transparent display 110 is made opaque. A vehicle display apparatus 100A illustrated in FIG. 4 is obtained by adding two transparent displays 110A between a mask layer 112 and a window glass 200 to the vehicle display apparatus 100 illustrated in FIG. 1, and replacing the display processing device 120 with a display processing device 120A. The display processing device 120A is obtained by adding a display processing unit 124A to the display processing device 120, and replacing the application processing unit 122 with an application processing unit 122A, to which an advertisement application is added.

When the mask layer 112 is made opaque by the mask processing performed by the mask setting unit 126, an advertisement screen generated by executing an advertisement application by the application processing unit 122A is displayed on the transparent display 110A by the display processing unit 124A.

In the embodiment described above, the case where the mask processing is performed from the viewpoint of protecting the privacy of the user, ensuring confidentiality of company information, or the like, has been described. However, opportunities of the mask processing may be limited such that the mask processing may be performed only when there is a third party outside the vehicle who can view the image of the content displayed on the transparent display 110.

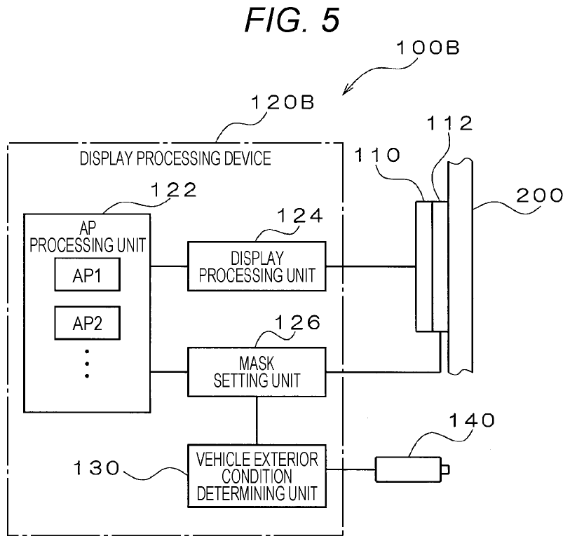

FIG. 5 is a diagram illustrating another modification example in which opportunities of the mask processing are limited depending on a situation outside the vehicle. A vehicle display apparatus 100B illustrated in FIG. 5 is obtained by adding a camera 140 to the vehicle display apparatus 100 illustrated in FIG. 1, and replacing the display processing device 120 with a display processing device 120B. In the display processing device 120B, an external situation determining unit 130 is added to the display processing device 120.

The camera 140 images surroundings of a host vehicle within a range in which the transparent display 110 can be viewed from the outside of the vehicle, the range being an imaging range. The external situation determining unit 130 determines, from an image of the periphery of the host vehicle captured by the camera 140, the presence or absence of a parallel running vehicle when the host vehicle is running, and the presence or absence of a pedestrian or a vehicle that is stopped side by side when the host vehicle is waiting for a traffic light or the like and stopped. When it is determined that there is a vehicle or a pedestrian, the mask setting unit 126 performs the mask processing, and in other cases, the mask setting unit 126 does not perform the mask processing. Consequently, opportunities for the mask processing can be minimized.

In the embodiment described above, the description has been given assuming that a vehicle runs on a road, but the present disclosure may be applied to another vehicle, such as an express train or a bullet train traveling on a track. Consequently, for example, in a case where a private room on the express train, the bullet train, or the like is used, a case where an entire car thereof is reserved, or the like, it is possible to prevent an image displayed on a transparent display installed on a window of a vehicle from being viewed by a user of another train traveling in parallel, or a third party on a platform at the time of stopping at a station.

As described above, according to the present disclosure, the mask unit is disposed to overlap a back side of a transparent display installed on a window of a vehicle, and the visibility of the mask unit may be varied. In this manner, it is possible to display an image of content normally while scenery outside the vehicle is viewed through the window, and it is possible to reduce the visibility of the image of the content from the outside of the vehicle simply by changing settings of the mask unit. Hence, it is possible to prevent peeping at display information (content) by a simple configuration and simple processing details.

Specific embodiments and specific examples of the present disclosure have been described above with reference to the attached drawings. The specific embodiments and specific examples described above are only specific examples of the present disclosure, which are used to understand the present disclosure, rather than limit the scope of the present disclosure. Those skilled in the art can make various modifications, combinations and reasonable omissions of elements in specific embodiments and specific examples based on the technical ideas of the present disclosure, and the embodiments thus obtained are also included in the scope of the present disclosure. For example, the above-mentioned embodiments and specific examples may be combined with each other, and the combined embodiments are also included in the scope of the present disclosure. Therefore, it is intended that this disclosure not be limited to the particular embodiments disclosed, but that the invention will include all embodiments falling within the scope of the appended claims.

What is claimed is:

1. A vehicle display apparatus comprising:
a transparent display that is installed on a window of a vehicle and displays an image of content which is a display target;
a mask unit that is disposed to overlap the transparent display and is capable of changing a visibility of a display region of the image as viewed from outside the vehicle; and
a visibility setting unit that sets a visibility of the mask unit depending on details of the content.

2. The vehicle display apparatus according to claim 1, wherein the visibility setting unit changes the visibility by varying transparency of the mask unit.

3. The vehicle display apparatus according to claim 2, wherein the visibility setting unit reduces visibility by switching from a transparent screen to an opaque screen.

4. The vehicle display apparatus according to claim 3, wherein the opaque screen is a screen of a predetermined color.

5. The vehicle display apparatus according to claim 4, wherein the predetermined color is black.

6. The vehicle display apparatus according to claim 1, wherein the visibility setting unit reduces the visibility of the mask unit when the details of the content are a target of privacy protection.

7. The vehicle display apparatus according to claim 1, wherein the visibility setting unit reduces the visibility of the mask unit when the details of the content are a target of confidentiality.

8. The vehicle display apparatus according to claim 1, wherein the visibility setting unit reduces the visibility of the mask unit when the details of the content are a target of external viewing.

9. The vehicle display apparatus according to claim 1, wherein the visibility setting unit does not reduce the visibility of the mask unit when the details of the content indicate information that complements a background that is visible to an occupant of a host vehicle through the transparent display, the information to be displayed assuming a state in which the background is visible.

10. The vehicle display apparatus according to claim 1, wherein the visibility setting unit reduces the visibility of the mask unit when the details of the content do not indicate information to be displayed assuming a state in which a background is visible to an occupant of a host vehicle through the transparent display.

11. The vehicle display apparatus according to claim 1, wherein
the mask unit is capable of changing a visibility of a part of a display region of the transparent display, and
the visibility setting unit reduces the visibility of the mask unit for the part of the display region when the content to be displayed with a visibility reduction corresponds to the part of the display region.

12. The vehicle display apparatus according to claim 1, wherein
the content is associated with metadata indicating whether or not a visibility reduction needs to be performed by the mask unit, and
the visibility setting unit sets the visibility of the mask unit based on the metadata.

13. The vehicle display apparatus according to claim 1, wherein
whether or not a visibility reduction needs to be performed by the mask unit is set for each application that displays an image of the content, and
the visibility setting unit sets the visibility reduction for the mask unit when setting indicating that the visibility reduction needs to be performed is provided for an application that displays the image of the content.
